(19) United States
(12) Patent Application Publication
(10) Pub. No.: US 2010/0134816 A1
(43) Pub. Date: Jun. 3, 2010

(54) SYSTEMS AND METHODS FOR CONTROL OF MULTIFUNCTION PERIPHERALS

(75) Inventor: Nehal Dantwala, Newport Beach, CA (US)

Correspondence Address: KNOBBE, MARTENS, OLSON, & BEAR, LLP, 2040 MAIN STREET, FOURTEENTH FLOOR, IRVINE, CA, 92614, US

(73) Assignee: Samsung Electronics Co., Ltd., Suwon City (KR)

(21) Appl. No.: 12/326,765

(22) Filed: Dec. 2, 2008

(51) Int. Cl. G06F 3/12

(52) U.S. Cl. 358/1.13; 358/1.15

(57) ABSTRACT

Systems and methods for automation of multi-function peripheral devices (MFPs) are disclosed. MFPs are configured to identify MFP users and to obtain one or more preferences associated with the identified users. Such preferences may be configured in advance and may provide instructions that allow the MFP to automatically scan and distributes documents provided to the MFP by the user with limited to no user input after user identification. The user preferences may further specify one or more document services to which scanned documents are transmitted. Examples of document services may include, but are not limited to, storage devices and servers, as well as output devices, such as fax and printer devices.

### BACKGROUND

1. Field of the Invention

Embodiments of the present disclosure pertain to multifunction peripheral devices and, in particular, to systems and methods for automating document scanning and electronic distribution of the scanned documents.

2. Description of the Related Art

Multifunction peripherals (MFPs) are devices which incorporate the functionality of multiple devices in a single device. For example, an MFP may incorporate one or more of printers, scanners, copiers, and fax machines. MFPs have recently grown in popularity, especially in small businesses and homes, due to the small amount of space they occupy in comparison to the individual devices they replace.

Adoption of the scanning functionality of MFPs has been slow, however. Typically, scanning is employed to generate a digital copy of a hardcopy document. In this process, a user generally navigates through two or more levels of a menu of the MFP user interface in order to come to the scan functions. However, even when the correct menu page of the user interface is reached, a number of menu fields may require input from the user before the scan can be started. As users may encounter difficulties in navigating the MFP menu, as well as entering scanning information into the MFP menu, the complexities associated with scanning may dissuade some users from employing this functionality.

### SUMMARY

Embodiments of the present disclosure provide a document management system. The document management system comprises one or more electronic document services that are configured to receive electronic reproductions of documents. The document management system further comprises a user preference service that stores one or more document distribution preferences associated with a multifunction peripheral user. The document management system additionally comprises a multifunction peripheral device in communication with the electronic document and user preference services.

In an embodiment, the MFP is operative to retrieve the document distribution preferences of an MFP user from the user preference service. In another embodiment, the MFP is operative to generate an electronic reproduction of a physical document. In a further embodiment, the MFP is operative to transmit the electronic reproduction to the electronic document service specified by the retrieved user document distribution preferences.

Further embodiments of the present disclosure provide a method of touchless document management. The method comprises identifying one or more document scanning parameters associated with a user of a multifunction peripheral device. The method also comprises converting one or more physical documents into one or more electronic reproductions in accordance with the document scanning parameters. The method additionally comprises transmitting the one or more electronic reproductions to a document service configured to receive the electronic reproductions for one or more of storage and physical output. In certain embodiments, the document service is selected according to the document scanning parameters. The document scanning parameters also provide sufficient instructions so as to allow the MFP to operate automatically upon receipt of the documents.

In another embodiment of the present disclosure, a multifunction peripheral device is provided. The MFP comprises a scanner operative to receive physical documents and generate an electronic reproduction of a physical document. The MFP also comprises a user interface component. The user interface component is operative to identify an MFP user, retrieve user preferences of an MFP user, and transmit the electronic reproduction to an electronic document service specified by the retrieved user preferences. The user preferences pre-configure the MFP such that the operations of the scanner and user interface component are performed automatically upon receipt of the physical documents by the scanner.

### BRIEF DESCRIPTION OF THE DRAWINGS

FIG. 1 is a block diagram of one embodiment of an operating environment for electronic conversion and distribution of documents;

FIGS. 2A-2C are block diagrams illustrating an embodiment of the operation of the MFP within the operating environment of FIG. 1;

FIGS. 3A-3D are embodiments of illustrative user interfaces generated by an MFP user interface that assist in the operation and configuration of the MFP; and

FIG. 4 is a flowchart depicting illustrative operation of the MFP during electronic conversion and distribution of documents.

### DETAILED DESCRIPTION

Embodiments of the present disclosure pertain to systems and methods for touchless control of multifunction peripheral devices (MFPs). An MFP may identify MFP users and receive one or more preferences associated with the identified users. These preferences may be employed by the MPF to specify the manner in which the MFP electronically scans and distributes documents provided to the MFP. In certain embodiments, user preferences may specify one or more document services that electronic reproductions of hardcopy documents, or scans, are to be sent. In other embodiments, user preferences may specify the degree of automation that the MFP employs when receiving documents. Examples of the document service may include, but are not limited to, storage devices and servers, as well as output devices, such as fax and printer devices.

Beneficially, in this manner, MFPs may receive instructions of how to electronically distribute documents with limited to no instructions by the user at the time the user provides the MFP with documents. As a result, the user may be spared the need to navigate MFP menus and/or enter information into the MFP in order to scan and distribute documents. Furthermore, the relative ease of document scanning and distribution enabled with embodiments of the touchless control system may encourage users of all experience levels to employ the MFP for document distribution, in lieu of sending physical documents. In at least these ways, the MFP user may employ the MFP to simply and efficiently scan and distribute documents, enhancing the user's productivity.

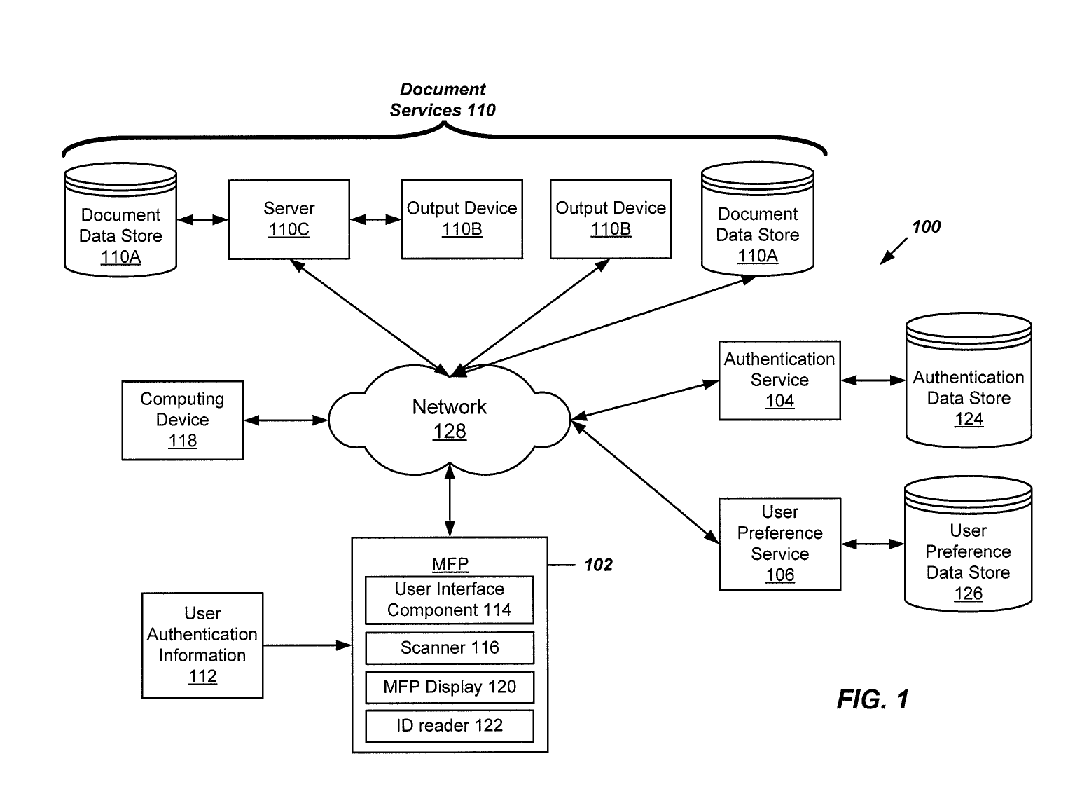

FIG. 1 presents an embodiment of an illustrative operating environment 100 for electronic reproduction and distribution of documents. The operating environment 100 includes a multifunction peripheral device (MFP) 102, an authentication service 104, a user preference service 106, one or more document services 110, and a network 128. The MFP 102 may communicate with the authentication service 104 in order to identify MFP users and to further communicate the identity of the MFP users to the preference service 106. In response to this communication, the preference service 106 may return document scanning and distribution preferences for the user, also referred to as user scan preferences or user preferences. Thus, the MFP 102 may employ the user scan preferences in conjunction with any document scanning and distribution operations performed by the MFP 102, enabling the MFP 102 to automatically scan and distribute electronic reproductions of documents with little to no user input to the MFP 102.

The MFP 102, in an embodiment, comprises a device which incorporates the functionality of multiple devices in a single device. For example, the MFP 102 may comprise devices capable of performing a plurality of functions including, but not limited to, printing, scanning, copying, and faxing.

As illustrated in FIG. 1, the MFP 102 may further comprise a user interface component 114, a scanner 116, a display 120, and an identification (ID) reader 122. The MFP 102 may further include a control interface comprising alpha-numeric keypads and other specialty keys for use in inputting commands and other information to the MFP. Such a control interface may be a physical control interface or a virtual control interface that is provided by the display.

In certain embodiments, the scanner 116 may include, but is not limited to, flatbed scanners, automated document feeders (ADFs), and combinations thereof, allowing documents to be provided to the MFP 102 singly or as multiple pages. In certain embodiments, if single document pages are provided to the scanner, the MFP 102 may scan and distribute scans of the document pages individually. In other embodiments, if multiple document pages are provided to a scanner 116 comprising an ADF, the MFP 102 may scan and distribute scans of all the pages inserted within the ADF together. In additional embodiments, if the number of documents to scan exceeds the capacity of the ADF, then the documents may be distributed in multiple transmissions, each of which is equal to or less than the capacity of the ADF.

The MFP 102 may further comprise a plurality of MFPs, located in a single location or multiple locations, as necessary. In systems 100 where a plurality of MFPs are present, the plurality of MFPs may further communicate with each other, such as through the network 128, and perform any combination of functions discussed herein with respect to the MFP 102.

The MFP 102 may also comprise network interfaces, memory, processing units, computer readable medium drives, and combinations thereof, all of which may communicate with one another by way of a communication bus. The network interface may provide connectivity for the MFP 102 over the network 128 and/or other networks or computer systems. The processing unit may communicate to and from memory, which contains computer program instructions that the processing unit executes in order to operate the MFP 102. The memory generally includes RAM or ROM and/or other persistent and auxiliary memory.

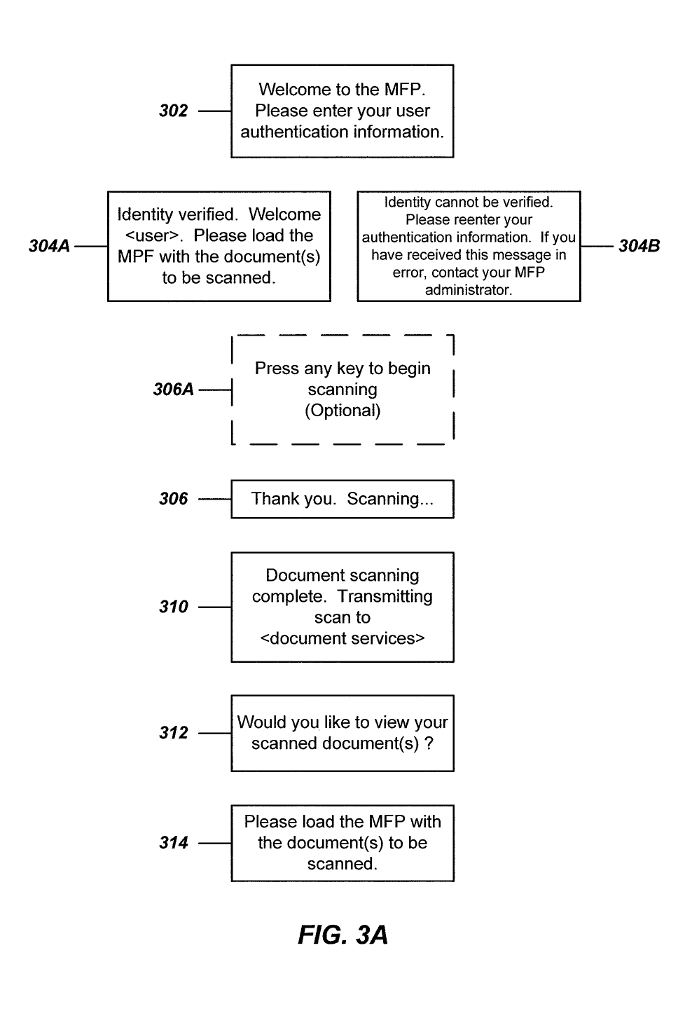

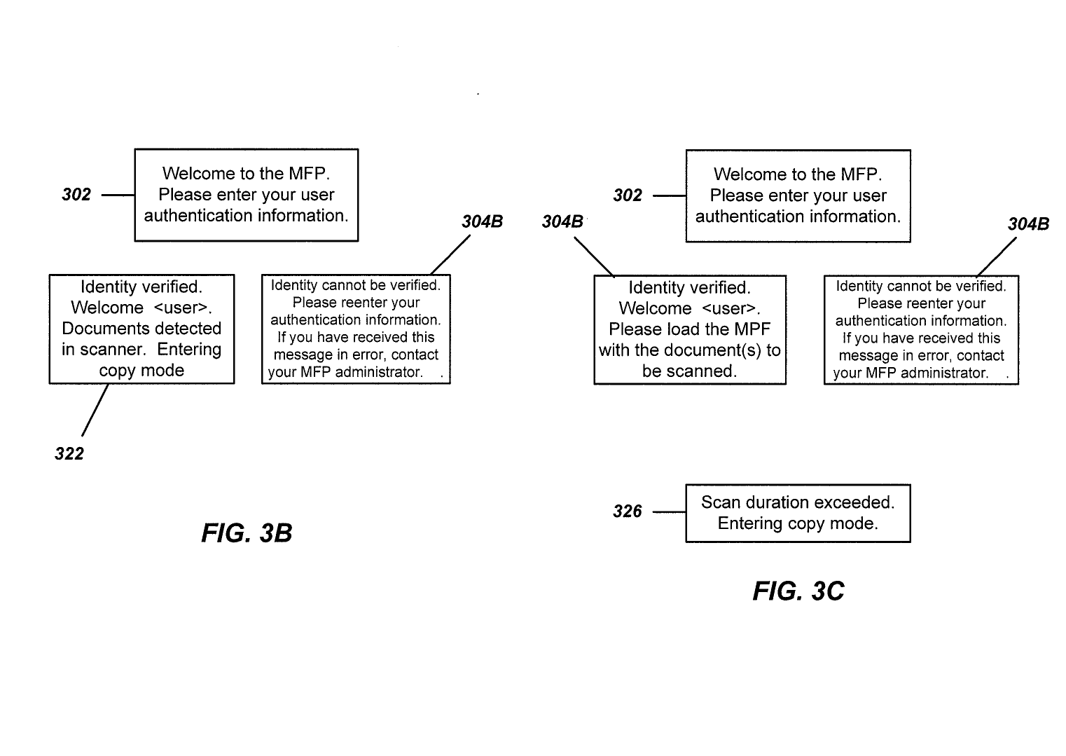

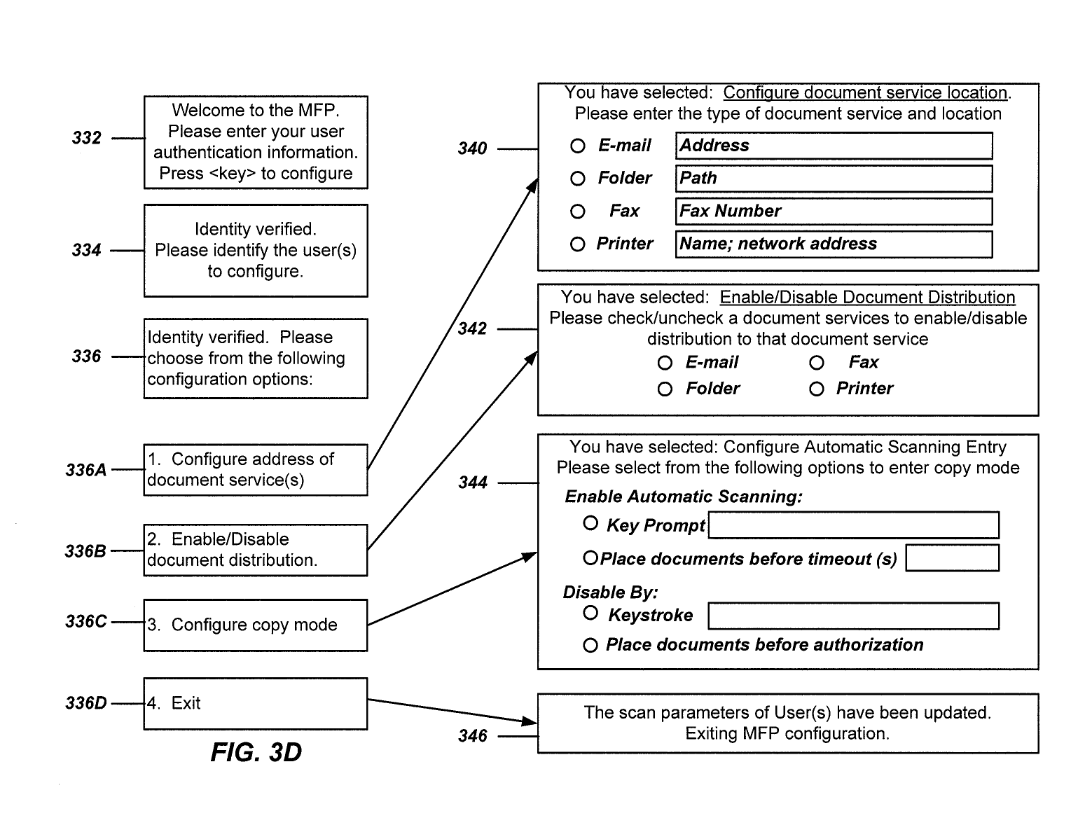

In one embodiment, the MFP memory may include the user interface component 114, which generates user interfaces and/or instructions, such as those illustrated in FIGS. 3A-3B. For example, user interfaces generated by the user interface component 104 may be populated within any combination of MFP display 120, computing devices 118, and the MFP ID reader 122, allowing users to interact with the MFP 102 for purposes such as authentication and configuration of the user scan preferences.

The MFP 102 may identify users and obtain user scan preference information by receipt of user authentication information 112 via the MFP ID reader 122. The MFP ID reader 122 may comprise one or more software and hardware components capable of receiving user authentication information 112, including, but not limited to, passwords, computer codes, identification cards, and human biometric characteristics (e.g., fingerprints, retinal patterns, and the like). Examples of MFP ID readers 122 may include, but are not limited to, keypads, card readers, and biometric readers.

The MFP 102 may communicate with the authentication service 104 in order to authenticate and identify the user. The authentication service 104, in certain embodiments, may be in communication with an authentication data store 124 that stores correlations between user authentication information 112 and authorized users of the MFP. The authentication service 104 may employ programmed logic to analyze data maintained by the authentication data store 124 for a match to the user authentication information 112, authenticating the user and determining their identity. If the user cannot be identified by the authentication service, the MFP 102 may prompt the user for additional user authentication information 112, for example, using MFP displays 120, MFP ID readers 122, and combinations thereof.

If, however, the user identification information 128 is authenticated by the authentication service 104, the user's identity may be transmitted to the user preference service 106, either directly or via the MFP 102. The user preference service 106 may be in communication with a user preference data store 126 that maintains associations between users and user preference information. The user preference service 106 employs programmed logic to search the user preference data store 126 for user preference information corresponding to a received user identity and returns that preference information to the MFP 102.

The user preference information may provide the MFP 102 with information necessary to automate the document scanning and distribution process. In one embodiment, the user preferences may comprise information pertaining to imaging settings of the scanned documents, such as page size, scan resolution, copy ratio, transparency, scan type (e.g., text, image, combined text and image), white level, dark level, color levels, brightness and contrast. In another embodiment, the user preferences may comprise information pertaining to the organization of scanned images, such as sidedness of the scan (e.g., 1-sided and 2-sided), the documents to be scanned as compared to the physical organization of the documents (e.g., all sheets, every n^{th} sheet), and collating the scanned documents.

The user preference information provided by the user preference service 106 may further comprise preference information relating to one or more of the document services 110 to which the scanned documents are distributed or transmitted. In one embodiment, the document services 110 may comprise electronic devices capable of receiving scanned documents from the MFP 102 through the network 128.

The document services 110 may perform functions such as storage of the scanned documents and/or output of physical copies of the scanned documents. Embodiments of document services 110 that store scanned documents may include, but are not limited to, document data stores 110A, such as magnetic storage devices, optical storage devices, and solid state storage devices. Embodiments of document services 110 that output physical copies of the scanned documents may include, but are not limited to, fax machines and printers. The document data stores 110A and output devices 110B may further be in direct communication with the MFP 102 through the network 128 or may communicate with the MFP 102 through servers 110C. Examples of servers 110C may include, but are not limited to, file servers and e-mail servers.

In certain embodiments, the user preferences may comprise a network location of one or more data stores 110A, output devices 110B, and servers 110C. For example, the network location may comprise a URL address, IP address, e-mail address, telephone number, and combinations thereof. When the user preferences specify one or more data stores 110, the user preferences may further comprise one or more directories of the document data store 110A.

In certain embodiments, the user interface component 114 may generate user interfaces that are accessible by users and administrators of the MFP 102 via the MFP display 120 and/or computing devices 118 in order to input user scan parameters associated with respective users. For example, the MFP display 120 and computing device 118 may include one or more hardware or software components capable of receiving user interfaces generated by the MFP 102. The computing devices 118 may include, but is not limited to, personal computers, laptop computers, landline telephones, mobile phones, terminals, and set top boxes. These user configuration parameters provided to the MFP 102 through user interfaces generated by the user interface component 114 may be transmitted by the MFP 102 to the user preference service 106 for storage by the user scan preference data store 126.

In alternative embodiments, users and/or administrators of the MFP 102 may communicate directly with the user preference service 106, without the MFP 102 as an intermediary, in order to input the user configuration parameters.

In certain embodiments, the user interface component 114 may further generate user interfaces that are accessible by users and administrators of the MFP 102 via the MFP display 120 and/or computing devices 118 in order to input MFP scan configuration parameters associated with respective users. In one embodiment, the MFP scan configuration parameters may designate whether the automatic scanning processes discussed herein are enabled. In further embodiments, the MFP scan configuration parameters may designate which of the document services 110 are to be employed for document distribution. Thus, default preferences for one or more document services may be provided with the user scan preference information, however, documents may only be distributed to the document services 110 designated by the scan configuration parameters. In one embodiment, the scan configuration parameters associated with respective users may be transmitted to the user preference service for storage by the user preference data store 126.

In certain embodiments, the MFP 102 may communicate with the authentication and user preference services 104, 106 through the network 128. In alternative embodiments, any of the authentication service 104, authentication data store 124, user preference service 106, and user preference data store 126 may be incorporated within the MFP 102 or communicate directly with the MFP 102. In additional embodiments, the authentication service 104 and user preference service 106 may be combined in a single service that performs the functions described herein for the services 104, 106 individually. In other embodiments, the data stored within the authentication data store 124 and the user scan preference data store 126 may be distributed across one or more data stores that function as described herein for the individual data stores 124, 126.

As further illustrated in FIG. 1, the network 128 may comprise the Internet. In other embodiments, the network 128 may comprise Personal Area Networks (PANs), Local Area Networks (LANs), Wide Area Networks (WANs), landline telephone networks, cellular telephone networks, cable networks, satellite networks, and combinations thereof. In addition, the network 128 may be a wired network or a wireless network.

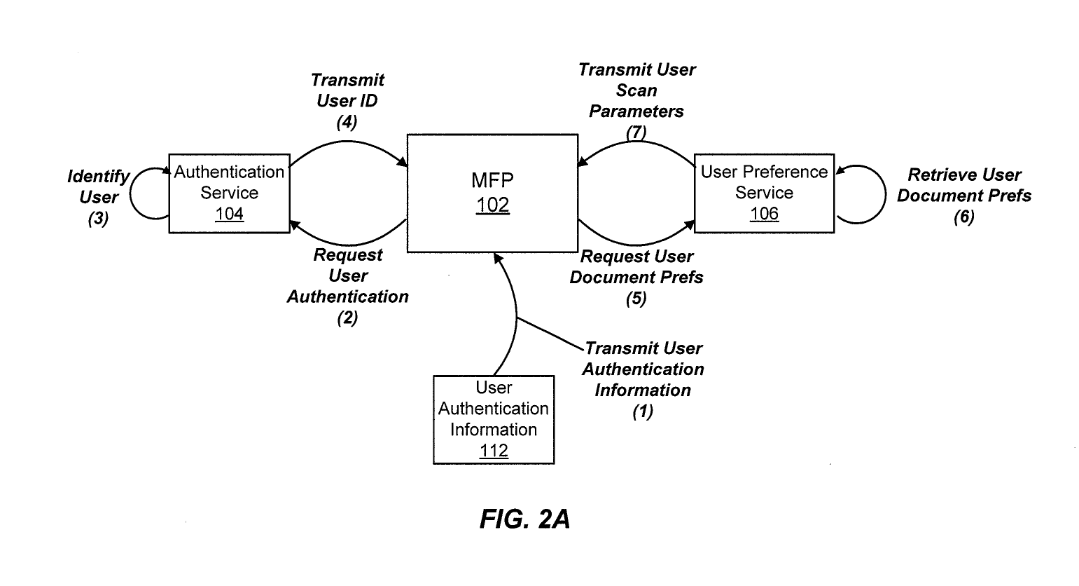

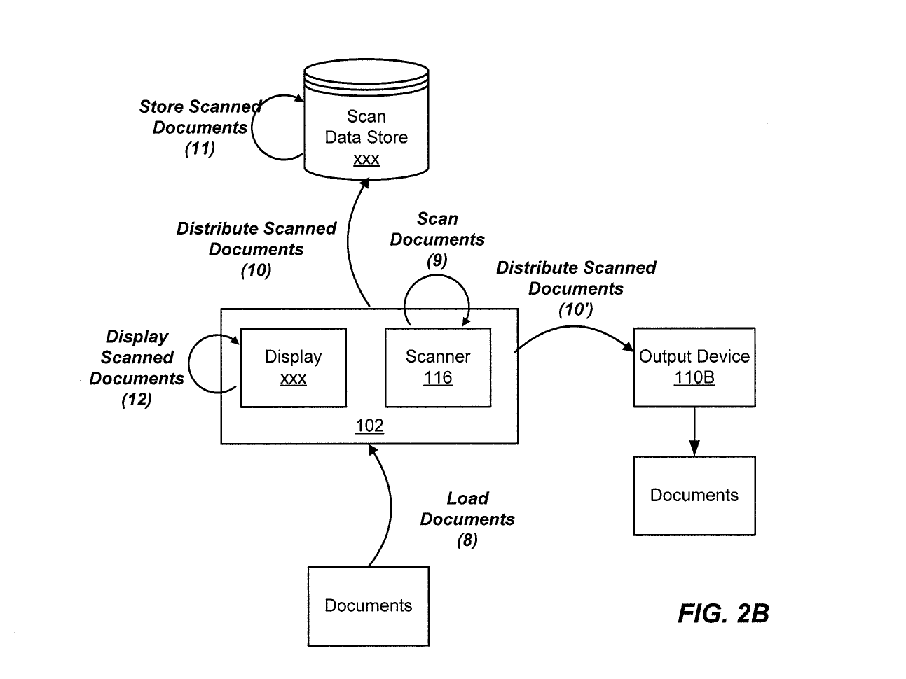

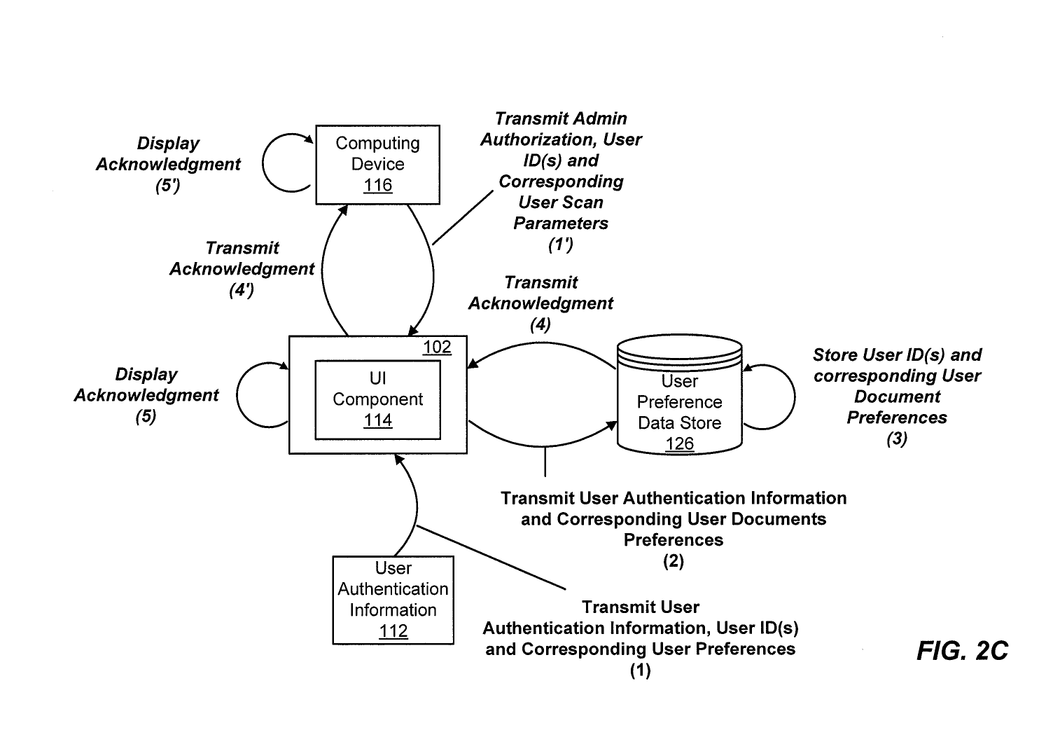

FIGS. 2A-2C are block diagrams of embodiments of the operation of the MFP 102 within the operating environment 100 of FIG. 1. FIGS. 2A-2B are further discussed in connection with FIGS. 3A-3B, which illustrate embodiments of user interfaces generated by the user interface component 114 for display to the user and/or administrator during operations including, but not limited to, user authentication, scan parameter input, and MFP configuration.

FIG. 3A illustrates embodiments of user interfaces that may be employed by the MFP 102 for user authentication, user prompts, and status updates. For example, user interface 302 may prompt the user to enter their user authentication information 112. After entry, the user authentication information 112 entered in the MFP 102, such as through the ID reader 122, may be transmitted to the user authentication service 104 for authentication, as illustrated in FIG. 2A. Upon receipt of the user authentication information 112, the authentication service 104 may query the authentication data store 124 and return the corresponding user identification to the MFP 102. In turn, the MFP 102 may provide the user identity to the user preference service 106, which returns the MFP scan parameters associated with the user identity.

With authentication of the user by the authentication service 104, the user interface component 114 may provide the user with a prompt 304A that indicates the user identity has been verified and prompts the user to load the documents to be scanned into the scanner of the MFP 102. Alternatively, if the user cannot be authenticated, the user interface component 114 provides the user with a prompt 304B to reenter their user authentication information 112 or contact their MFP administrator to report an error.

In certain embodiments, upon receipt of documents after user authorization (FIG. 2B), the MFP 102 may proceed to automatically begin generating electronic reproductions of the provided documents with the scanner 116. The user interface component 114 may further generate a status update in a user interface 306 that confirms receipt of the documents and that the scanning process is ongoing.

In alternative embodiments, the MFP 102 may prompt the user in a user interface 306A for a user signal, such as one or more keystrokes that are input through the control interface of the MFP 102, prior to beginning the scanning process. Once the user input is provided, the MFP 102 may operate automatically. Whether the MFP 102 scans and distributes documents automatically upon receipt or requests a user prompt prior to automatic document scanning and distribution may be determined by the user preferences, as discussed below.

After completion of the scanning process, the MFP 102 may proceed to distribute the scanned documents in accordance with the user scan parameters received from the user preference service 106. The user interface component 114 may generate a status update in a user interface 310 that confirms completion of the scanning process and may list the document services to which the scanned documents are being distributed. In certain embodiments, user interface 312 may further allow the user to view the scanned and distributed documents, if desired.

User interface 314 may further prompt the user to insert additional documents to be scanned and distributed, at the user's discretion. Should the user insert additional documents for scanning, the user interface component 114 returns to display user interface 304A.

In further embodiments, the MFP 102 may allow the user to bypass the automatic MFP operations discussed above without navigating menus of the MFP. Examples are illustrated in FIGS. 3B and 3C. In the embodiment of FIG. 3B, the user may place their documents within the scanner 116 prior to providing their user authorization information 114 when prompted in user interface 302. In the embodiment of FIG. 3C, after user authentication, the user provides the documents to the scanner 116 after a selected period of time. In response to either of these cases, the MFP 102 may detect the timing of document placement and not automatically begin scanning and distributing documents. For example, the MFP may enter a copy mode where the MFP 102 functions as a copier, rather than automatically scanning and distributing the documents.

FIGS. 2C and 3D present embodiments of the operation of the MFP 102 and illustrative user interfaces 332-346, respectively, during an MFP configuration process. In the configuration process, the user scan parameters may be provided for storage by the scan parameter service 106, for example, by the user preference data store. In certain embodiments, as illustrated in FIG. 2C, the user scan parameters may be provided to the user preference service 106 via the MFP 102. In certain embodiments, the user scan parameters may be provided to the MFP 102 via a control interface of the MFP 102. In other embodiments, the user scan parameters may be provided to the MFP 102 remotely by computing devices 118. The user may interact with user interfaces generated by the user interface component 114 during configuration using any combination of computing devices 118, the MFP display 120, and ID reader 122.

In user interface 332, the user is prompted to enter their user authentication information 112. To distinguish entry into MFP configuration, as opposed to MFP operation, in certain embodiments, the user may depress a key, key sequence, or button before, during, and/or after entry of user authentication information 112.

Upon entry of the user authentication information 112, the user interface 334 may optionally be provided, if the authenticated user is an MFP administrator. User interface 334 may allow an administrator to enter scan preferences for multiple MFP users, allowing the administrator the convenience of configuring multiple MFP users simultaneously. Upon entry of the user(s) whose preference information is to be input, user interface 336 may be displayed, providing a menu of configuration options, such as 336A, 336B, 336C, and 336D, which may be selected. In contrast, upon entry of the user authentication information 112, non-administrative users of the MFP 102 may be presented with the menu of user interface 336 directly from authentication user interface 332, reflecting that non-administrative users may input only their personal scan preferences, not scan preferences for other users.

In user interface 336A, locations of the document service 110 within the network 128 may be modified. Upon selection of this option, user interface 340 may be presented. A selection of available document services 110 may be provided, including, but not limited to, printers, fax machines, storage device folders, and e-mail. Those of skill in the art may understood that these document services 110 are presented for example purposes and other document services 110 may be presented as options without limit. For each of the document services 110, information necessary to distribute the scanned documents to the document service 110, such as one or more email addresses, paths, telephone numbers, and network names/IP addresses, may be provided.

It may be further understood that other user scan parameters may be similarly entered through additional interfaces similar to user interfaces 336, 340. For example, additional user interfaces allowing entry of user scan parameters including, but not limited to, page size, scan resolution, copy ratio, transparency, scan type (e.g., text, image, combined text and image), white level, dark level, color levels, brightness and contrast, such as sidedness of the scan (e.g., 1-sided and 2-sided), the documents to be scanned as compared to the physical organization of the documents (e.g., all sheets, every n^{th} sheet), and collating the scanned documents, may be provided.

In user interface 336B, the user may elect to enter user interface 342, which allows the document services 110 that are to be enabled or disabled for distribution to be selected. By selecting or unselecting a document service in user interface 342B, scanned documents will be sent or not sent, respectively, to that document service 110.

In user interface 336C, the user may elect to enter user interface 344. In one aspect, user interface 344 may allow the user to select the manner in which the MFP 102 performs automatic scanning and distribution. For example, as discussed above with respect to user interfaces 302-314 of FIG. 3A, in one embodiment, the MFP 102 may perform automatic scanning and distribution after responding to a prompt with a single keystroke. Alternatively, the user may configure the MFP to perform automatic scanning and distribution if documents are provided to the MFP within a selected time window after authentication.

In alternative embodiments, the user may use user interface 344 to select the manner in which the MFP 102 may be instructed not to perform automatic scanning and distribution. For example, the user may select that a selected keystroke inhibits the MFP 102 from performing automatic scanning and distribution. Alternatively, the user may select that documents placed within the MFP scanner 116 before authentication are not scanned and distributed automatically. Those of skill in the art may realize that other triggers for enabling and disabling automatic document scanning and distribution may also be provided, as necessary, without departing from the disclosed embodiments.

In user interface 336D, the user may choose to exit from the configuration menu. In response, a user interface 346 may be displayed, acknowledging exit from the configuration menu and confirming that the user scan parameters are updated.

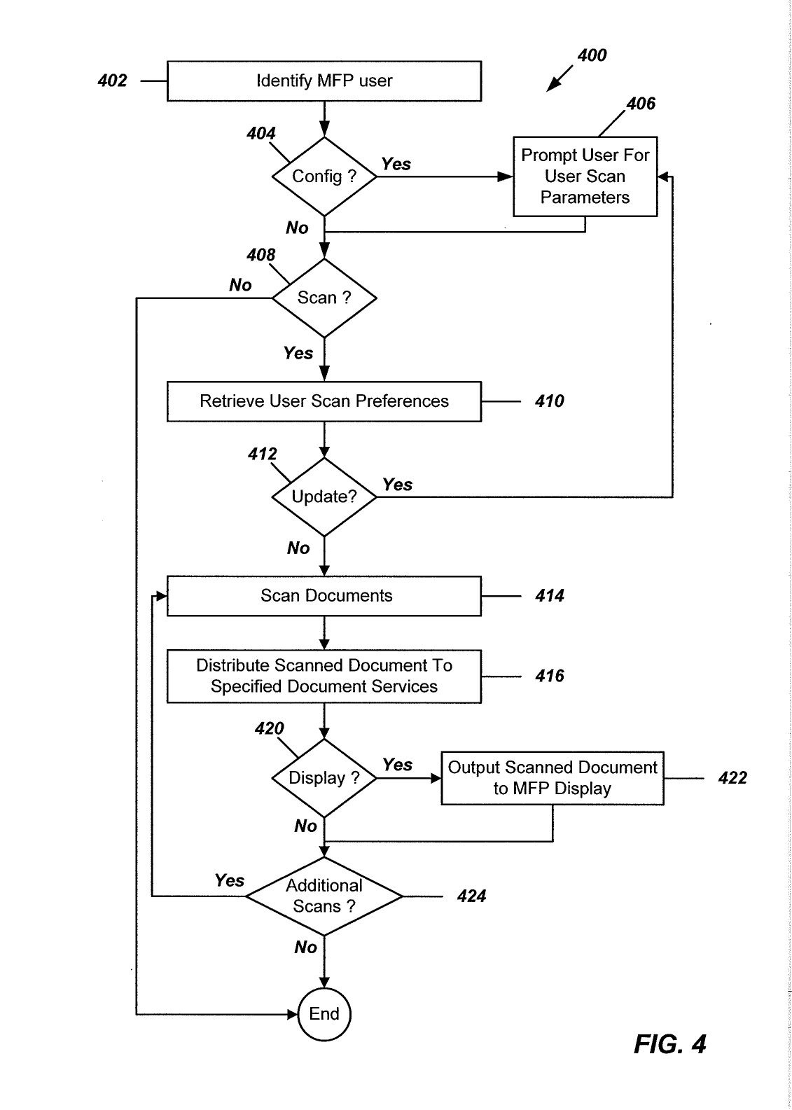

FIG. 4 is a flow diagram 400 depicting an illustrative process implemented by the MFP 102 to allow configuration and execution of automatic document scanning and distribution operations. In block 402, the MFP 102 identifies an MFP user, such as through confirmation of one or more user authentication information 112.

In decision block 404, upon identifying the user, the MFP 102 determines whether the user intends to configure the MFP 102. Such a determination may be made, for example, if the user enters a selected keystroke before, during, or after authentication. Should the user indicate their interest in configuring the MFP 102, the MFP 102 may enter the configuration mode, as discussed with respect to FIGS. 2C and 3D, and prompt the user to provide one or more user scan parameters to modify in block 406. If no further use of the MFP 102 is desired after configuration, the process may end.

However, if further use of the MFP 102 is desired after configuration, or configuration is not selected in block 404, the process 400 may move to decision block 408, where the MFP 102 determines if the MFP 102 is to be employed for automatic document scanning and distribution. If automatic document scanning and distribution is not to be performed, the process 400 may end and other functions of the MFP 102 may be employed. If automatic document scanning and distribution is to be performed, the MFP 102 may retrieve user scan preferences from the user preference service 106 in block 410.

In certain embodiments, the MFP 102 may examine the length of time since the user scan preferences were last updated in decision block 412. If this length of time exceeds a selected duration, then process 400 may move to block 406, where the MFP 102 may prompt the user to update their user scan parameters. Alternatively, if this length of time does not exceed the selected duration, the process may move to blocks 414 and 416, where the MFP 102 scans and distributes the documents in accordance with the user scan preferences obtained from the scan preference service 106.

In decision block 420, the MFP 102 may further query the user if they would like to have the scanned documents displayed. If the user elects to have the scanned documents displayed, the process moves to block 422, where the MFP 102 displays scanned documents, for example, using the MFP display 120. If the user elects not to have the scanned documents displayed, the process moves to decision block 424, where the user is further prompted for additional documents to scan. Should there be no further documents to scan, the process 400 ends. However, if additional scanning and distribution operations are desired, the process returns to block 414.

In summary, embodiments of the present disclosure provide MFPs 102, systems incorporating MFPs, and methods of employing MFPs 102 that provide automatic scanning and distribution of documents. The MFPs 102 may be configured such that, when a user is identified by the MFP 102, one or more user scan preferences associated with the user may be retrieved. This process pre-configures the MFP 102, allowing documents to be correctly scanned and distributed with little to no input from the user. In further benefit, the user scan preferences may be easily updated by the user and/or MFP administrators to reflect changes in user preferences and/or workflow. In this manner, the scanning functionality of MFPs 102 may be customized and simplified, enhancing user productivity.

Although the foregoing description has shown, described, and pointed out the fundamental novel features of the present teachings, it will be understood that various omissions, substitutions, and changes in the form of the detail of the apparatus as illustrated, as well as the uses thereof, may be made by those skilled in the art, without departing from the scope of the present teachings. Consequently, the scope of the present teachings should not be limited to the foregoing discussion, but should be defined by the appended claims.

What is claimed is:

1. A document management system, the system comprising:
one or more electronic document services that are configured to receive electronic reproductions of documents;
a user preference service that stores one or more document distribution preferences associated with a multifunction peripheral (MFP) user; and
a multifunction peripheral device (MFP) in communication with the electronic document and user preference services, the MFP operative to:
retrieve the document distribution preferences of an MFP user from the user preference service;
generate an electronic reproduction of a physical document; and
transmit the electronic reproduction to the electronic document service specified by the retrieved user document distribution preferences.

2. The document management system of claim 1, wherein the electronic document service comprises one or more of data storage devices, servers, and document output devices.

3. The document management system of claim 2, wherein the server comprises at least one of electronic mail servers and file servers.

4. The document management system of claim 2, wherein the document output devices comprise one or more of fax machines and printers.

5. The document management system of claim 1, wherein the MFP is further operative to identify the MFP user based upon an identification (ID) card.

6. The document management system of claim 1, wherein the MFP comprises the user preference service.

7. The document management system of claim 1, wherein the MFP generates and transmits the electronic reproductions of documents without user input after identifying the user.

8. A method of automatic document management, the method comprising:
identifying one or more document scanning parameters associated with a user of a multifunction peripheral device (MFP);
converting one or more physical documents into one or more electronic reproductions in accordance with the document scanning parameters; and
transmitting the one or more electronic reproductions to a document service configured to receive the electronic reproductions for one or more of storage and physical output;
wherein the document service is selected according to the document scanning parameters; and
wherein the document scanning parameters provide instructions sufficient to allow the MFP to operate automatically upon receipt of the documents.

9. The method of claim 8, wherein the document scanning parameters are identified by identifying an MFP user and retrieving user parameters associated with the identified user.

10. The method of claim 9, wherein the user is identified by correlating user authentication information provided to the MFP with a user identity.

11. The method of claim 8, wherein the document service comprises a data storage device.

12. The method of claim 11, wherein the document scanning parameters comprise at least one of a network location of the data storage device and a directory of the data storage device.

13. The method of claim 8, wherein the document service comprises an e-mail server.

14. The method of claim 13, wherein the document scanning parameters comprises an e-mail address.

15. The method of claim 8, wherein the document service comprises one of a fax machine and printer.

16. The method of claim 10, wherein the user authentication information is provided by an identification card.

17. The method of claim 10, wherein the user authentication information comprises one or more biometric characteristics of the user.

18. The method of claim 10, wherein the MFP converts and transmits the documents automatically without the input of commands from a user after identification.

19. The method of claim 10, wherein the MFP converts and transmits the documents automatically upon response to a prompt by the user after identification.

20. A multifunction peripheral device (MFP), comprising:
a scanner operative to receive physical documents and generate an electronic reproduction of a physical document; and
a user interface component that is operative to:
identify an MFP user;
retrieve user preferences of an MFP user; and
transmit the electronic reproduction to an electronic document service specified by the retrieved user preferences;
wherein the user preferences pre-configure the MFP such that the operations of the scanner and user interface component are performed automatically upon receipt of the physical documents by the scanner.

21. The multifunction peripheral device of claim 20, wherein the electronic document service comprises one or more of data storage devices, servers, and document output devices.

22. The multifunction peripheral device of claim 21, wherein the server comprises at least one of electronic mail servers and file servers.

23. The multifunction peripheral device of claim 21, wherein the document output devices comprise one or more of fax machines and printers.

24. The multifunction peripheral device of claim 21, wherein the MFP generates and transmits the documents automatically without the input of commands from a user after identification.

25. The multifunction peripheral device of claim 21, wherein the MFP generates and transmits the documents automatically upon response to a prompt by the user after identification.
